(19) United States
(12) Patent Application Publication
(10) Pub. No.: US 2011/0318238 A1
(43) Pub. Date: Dec. 29, 2011

(54) Spiral Cylinder-Shaped Discharge Unit for Ozone Generator

(75) Inventors: Jian Chen, Fujian (CN); Tao Wang, Fujian (CN)

(73) Assignee: FUJIAN NEWLAND ENTECH CO., LTD., Fujian (CN)

(21) Appl. No.: 13/117,289

(22) Filed: May 27, 2011

(30) Foreign Application Priority Data
May 29, 2010 (CN) 201010191396.4
May 29, 2010 (CN) 201020214844.3

(51) Int. Cl. B01J 19/08

(52) U.S. Cl. 422/186.19; 422/186.18

(57) ABSTRACT

The present invention provides a spiral cylinder-shaped discharge unit for an ozone generator, wherein the discharge unit comprises at least one ground electrode, at least one insulating layer and at least one high voltage electrode that are stacked together and integrally curled into a number of spiral cylinder-shaped coils, wherein the high voltage electrode and the ground electrode are separated by the insulating layer, and gaps are respectively present between the ground electrode and the insulating layer, and between the insulating layer and the high voltage electrode. The discharge unit is applicable to various kinds of ozone generator and can significantly improve ozone productivity of a single discharge unit and reduce manufacture cost.

### TECHNICAL FIELD

The present invention generally relates to the field of ozone generators, and more specifically to a discharge unit of an ozone generator.

### BACKGROUND ART

The discharge unit of current large ozone generators generally comprises a high voltage electrode, an insulating tube and a ground electrode installed concentrically in an outward sequence. Generally, a ceramic coated glass tube is used as the insulating tube and a stainless steel tube is used as the electrode material. Dried and purified air or oxygen is passed through a discharge gap between the electrode and the insulating layer, and ozone is generated in the gap when the power is turned on. The disadvantages of this kind of ozone generator lie in that each discharge unit is a separate assembly composed of concentrically installed high voltage electrode, insulating tube and ground electrode. A single discharge unit has low ozone productivity, and the entire ozone generator thus formed has a small specific surface area, such that it would be necessary for an ozone generator with large productivity to be provided with a large quantity of the said discharge units. In addition, since stainless steel, glass or ceramic materials are used, the whole apparatus would have a large volume and a complicated structure, occupy large area and involve high manufacture cost. Furthermore, since the high voltage electrode, the insulating tube and the ground electrode are concentrically arranged, installation requirement is stringent, and also the installation and maintenance cost is increased due to the vulnerability of the insulating tube to damage.

Therefore, there is a need for a discharge unit capable of overcoming at least some of the above defects, which has a large specific surface area and a high ozone productivity, and is of simple structure, occupies a small area, involves less maintenance cost and is easy for manufacture and installation.

### SUMMARY OF THE INVENTION

The object of the present invention is to provide a discharge unit for an ozone generator which involves less manufacture and maintenance cost, has a large specific surface area, and is easy for manufacture, installation and replacement.

The present invention provides a spiral cylinder-shaped discharge unit for an ozone generator The discharge unit comprises at least one ground electrode, at least one insulating layer and at least one high voltage electrode that are stacked together and integrally curled into several spiral cylinder-shaped coils, wherein the high voltage electrode and the ground electrode are insulated by the insulating layer, and gaps are present between the ground electrode and the insulating layer and between the insulating layer and the high voltage electrode, respectively.

To improve efficiency of the ozone generator, the present invention optionally comprises one or more of the following technical features:

1. The discharge unit is integrally curled into several spiral cylinder-shaped coils about one of its edge.

2. The discharge unit is integrally curled into several spiral cylinder-shaped coils about its fold line after being doubled up.

3. The discharge unit further comprises a shaft about which the stacked ground electrode, insulating layer and high voltage electrode are integrally curled into several spiral cylinder-shaped coils.

4. The gap between the ground electrode and the insulating layer is between 0.05-0.5 mm.

5. The gap between the high voltage electrode and the insulating layer is between 0.05-0.5 mm.

6. The high voltage electrode and the ground electrode are insulated by one insulating layer.

7. The high voltage electrode is only adjacent to the insulating layer.

8. The ground electrode is only adjacent to the insulating layer.

9. Material of the high voltage electrode and the ground electrode may be stainless steel, titanium, chromium, aluminum, or oxide thereof.

10. The ground electrode, the high voltage electrode and the insulating layer are curlable membrane-like.

11. The ground electrode, the insulating layer and the high voltage electrode are sequentially adjacent to each other.

12. Said gaps are achieved by spacing means.

13. Said spacing means comprise a plurality of protruding portions provided on one or both of the faces of the insulating layer.

14. Said spacing means comprise a plurality of protruding portions provided on one or both of the faces of the ground electrode and of the high voltage electrode.

15. Said protruding portions are glued to or integrally formed on one or both of the faces of the insulating layer.

16. Said protruding portions are glued to or integrally formed on one or both of the faces of the ground electrode and of the high voltage electrode.

17. Said protruding portions are point-shaped.

18. Said protruding portions are rib-shaped.

19. Said protruding portions are wave-shaped.

Advantages of the spiral cylinder-shaped discharge unit for an ozone generator of the present invention are as follows:

1. The discharge unit is curled into a number of layers to increase specific surface area, that is, a single discharge unit has a larger specific surface area compared with that of the prior art single discharge unit, thereby increasing ozone productivity of the single discharge unit and of an ozone generator comprising the same, and also reducing the manufacture cost.

2. Since ozone productivity of a single discharge unit is greatly increased, the volume of an ozone generator is substantially decreased compared with the prior art ozone generator with the same productivity, thereby reducing the occupied area.

3. The insulating layer is formed of a curlable material, which is invulnerable to breakage, safe to be used and less in cost.

4. The ground electrode, the high voltage electrode and the insulating layer are membrane-like, with a low cost in terms of manufacture and maintenance.

5. The discharge unit is formed by stacking and curling a set of ground electrode, high voltage electrode and insulating layer, which is easy for manufacture, installation and maintenance, and also less in cost.

### BRIEF DESCRIPTION OF THE DRAWINGS

FIG. 1 is a schematic view of the spiral cylinder-shaped discharge unit according to a first embodiment of the present invention, wherein the spacing means are omitted for the sake of clear illustration;

FIG. 2 is an expanded front view of the spiral cylinder-shaped discharge unit according to the first embodiment of the present invention;

FIG. 3 is an expanded side view of the spiral cylinder-shaped discharge unit according to the first embodiment of the present invention; and

FIG. 4 is a schematic view of the spiral cylinder-shaped discharge unit according to a second embodiment of the present invention, wherein the spacing means are omitted for the sake of clear illustration.

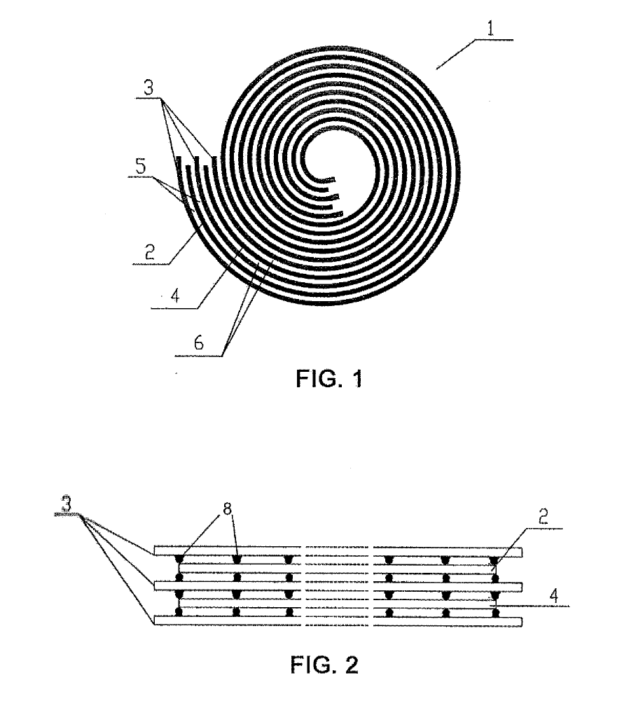

In FIGS. 1-4, reference numeral 1 represents a discharge unit, 2 represents a ground electrode, 3 represents an insulating layer, 4 represents a high voltage electrode, 5 represents a gap between an insulating layer and the ground electrode, 6 represents a gap between the high voltage electrode and the insulating layer, 7 represents a shaft, 8 represents spacing means in the form of point-shaped protruding portions.

### DETAILED DESCRIPTION OF THE PREFERRED EMBODIMENTS

The two embodiments of the present invention will be described in details in conjunction with the figures.

### Embodiment 1

As shown in FIGS. 1-3, a spiral cylinder-shaped discharge unit 1 for an ozone generator comprises at least one ground electrode 2, at least one insulating layer 3 and at least one high voltage electrode 4 that are curlable membrane-like and are stacked together and integrally curled, about one of its edge, into several spiral cylinder-shaped coils, wherein the high voltage electrode 4 and the ground electrode 2 are insulated by the insulating layer 3, and gaps 5, 6 respectively are present between the ground electrode 2 and the insulating layer 3, and between the insulating layer 3 and the high voltage electrode 4. In this embodiment, the spiral cylinder-shaped discharge unit 1 is formed by one layer of the ground electrode 2, three insulating layer 3 and one layer of the high voltage electrode 4 that are stacked together, wherein edges of the insulating layers 3 project beyond that of the ground electrode 2 and the high voltage electrode 4, and the gaps 5, 6 respectively are between 0.05-0.4 mm.

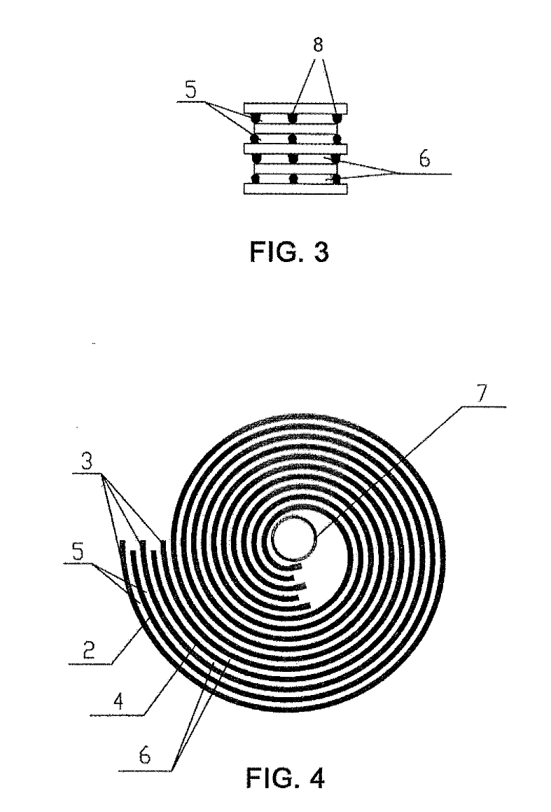

As can be clearly seen from FIGS. 2 and 3, there are spacing means between the ground electrode 2 and the insulating layer 3, and between the insulating layer 3 and the high voltage electrode 4, respectively, so as to ensure the gaps 5, 6 therebetween. In this embodiment, the spacing means take the form of a plurality of point-shaped protruding portions which are provided on one or both of the faces of the insulating layer e.g. by gluing. As an alternative, they may be provided on one or both of the faces of the ground electrode and of the high voltage electrode. Also, said spacing means can take other form than that shown in the figures, such as rib-shaped or wave-shaped protruding portions.

### Embodiment 2

Referring to FIG. 4, the spiral cylinder-shaped discharge unit of this second embodiment differs from that of the first embodiment in further comprising a shaft 7, about which the stacked ground electrode 2, the insulating layer 3 and the high voltage electrode 4 are integrally curled into a spiral cylinder-shape. The shaft 7 is a hollow tube into which may be directed water or other cooling medium in practice so as to achieve good heat dissipation. The shaft may be electrically connected to the high voltage electrode.

For the sake of clear illustration, the number of the coils of the spiral cylinder-shaped discharge unit in the embodiments shown in the figures is small, however, the number of the coils may be increased in practice according to actual needs. Though in the figures there are one high voltage electrode, one ground electrode and three insulating layers, the numbers thereof should in no way be limited thereto, as long as the high voltage electrode(s) and the ground electrode(s) are insulated by the insulating layer(s) and gaps are respectively present between the ground electrode(s) and the insulating layer(s) and between the insulating layer(s) and the high voltage electrode(s) after the discharge unit is curled into a spiral cylinder shape. For example, there may be one high voltage electrode, one ground electrode and two insulating layers, or there may be more than one high voltage electrode, more than one ground electrode and more than two insulating layers.

In practice, the stacked ground electrode(s) 2, insulating layer(s) 3 and high voltage electrode(s) 4 may be integrally doubled up once or more times before they are curled into several spiral cylinder-shaped coils about the fold line.

In the above two embodiments, the high voltage electrode and the ground electrode are separated by one insulating layer, however, in practice they may be separated by two or more insulating layers, and water or other cooling medium may be directed between two adjacent insulating layers so as to improve heat dissipation.

In order to achieve better heat dissipation, the ground electrode(s) and the high voltage electrode(s) may be made from stainless steel, titanium, chromium, aluminum or oxide thereof with good heat dissipation performance.

The spiral cylinder-shaped discharge unit of the present invention may be applicable to a variety of ozone generator and can significantly improve ozone productivity of a single discharge unit and of an ozone generator comprising the same, thus decreasing the volume of the system and the manufacture cost.

1. A spiral cylinder-shaped discharge unit for an ozone generator, wherein the discharge unit comprises at least one ground electrode, at least one insulating layer and at least one high voltage electrode that are stacked together and integrally curled into several spiral cylinder-shaped coils, wherein the high voltage electrode and the ground electrode are insulated by the insulating layer, and wherein gaps and respectively are present between the ground electrode and the insulating layer, and between the insulating layer and the high voltage electrode.

2. The spiral cylinder-shaped discharge unit for an ozone generator according to claim 1, wherein the discharge unit is integrally curled into a spiral cylinder-shape about one of its edges.

3. The spiral cylinder-shaped discharge unit for an ozone generator according to claim 1, wherein the discharge unit further comprises a shaft about which the stacked ground electrode, the insulating layer and the high voltage electrode are integrally curled into a spiral cylinder-shape.

4. The spiral cylinder-shaped discharge unit for an ozone generator according to claim 1, wherein the discharge unit is curled into a spiral cylinder-shape about its fold line after being integrally doubled up.

5. The spiral cylinder-shaped discharge unit for an ozone generator according to claim 1, wherein the gap between the ground electrode and the insulating layer is between 0.05-0.5 mm.

6. The spiral cylinder-shaped discharge unit for an ozone generator according to claim 1, wherein the gap between the high voltage electrode and the insulating layer is between 0.05-0.5 mm.

7. The spiral cylinder-shaped discharge unit for an ozone generator according to claim 1, wherein the ground electrode, the high voltage electrode and the insulating layer are membrane-like.

8. The spiral cylinder-shaped discharge unit for an ozone generator according to claim 1, wherein the ground electrode, the insulating layer and the high voltage electrode are sequentially adjacent to each other.

9. The spiral cylinder-shaped discharge unit for an ozone generator according to claim 1, wherein the high voltage electrode and the ground electrode are separated by one insulating layer.

10. The spiral cylinder-shaped discharge unit for an ozone generator according to claim 1, wherein the high voltage electrode and the ground electrode are separated by two or more insulating layers.

11. The spiral cylinder-shaped discharge unit for an ozone generator according to claim 1, wherein the high voltage electrode is only adjacent to the insulating layer.

12. The spiral cylinder-shaped discharge unit for an ozone generator according to claim 1, wherein the ground electrode is only adjacent to the insulating layer.

13. The spiral cylinder-shaped discharge unit for an ozone generator according to claim 3, wherein the shaft is hollow, and that water or other cooling medium can be directed into the shaft to enhance heat dissipation.

14. The spiral cylinder-shaped discharge unit for an ozone generator according to claim 10, wherein water or other cooling medium can be directed between two adjacent insulating layers to enhance heat dissipation.

15. The spiral cylinder-shaped discharge unit for an ozone generator according to claim 1, wherein said gaps and are achieved by spacing means.

16. The spiral cylinder-shaped discharge unit for an ozone generator according to claim 15, wherein said spacing means comprise a plurality of protruding portions provided on one or both of the faces of the insulating layer.

17. The spiral cylinder-shaped discharge unit for an ozone generator according to claim 16, wherein said protruding portions are glued to or integrally formed on one or both of the faces of the insulating layer.

18. The spiral cylinder-shaped discharge unit for an ozone generator according to claim 15, wherein said spacing means comprise a plurality of protruding portions provided on one or both of the faces of the ground electrode and of the high voltage electrode.

19. The spiral cylinder-shaped discharge unit for an ozone generator according to claim 18, wherein said protruding portions are glued to or integrally formed on one or both of the faces of the ground electrode and of the high voltage electrode.

20. The spiral cylinder-shaped discharge unit for an ozone generator according to claim 16, wherein said protruding portions are point-shaped.

21. The spiral cylinder-shaped discharge unit for an ozone generator according to claim 18, wherein said protruding portions are point-shaped.

22. The spiral cylinder-shaped discharge unit for an ozone generator according to claim 16, wherein said protruding portions are rib-shaped.

23. The spiral cylinder-shaped discharge unit for an ozone generator according to claim 18, wherein said protruding portions are rib-shaped.

24. The spiral cylinder-shaped discharge unit for an ozone generator according to claim 16, wherein said protruding portions are wave-shaped.

25. The spiral cylinder-shaped discharge unit for an ozone generator according to claim 18, wherein said protruding portions are wave-shaped.
